(19) United States
(12) Patent Application Publication
(10) Pub. No.: US 2022/0298315 A1
(43) Pub. Date: Sep. 22, 2022

(54) ANISOTROPIC CONDUCTIVE FILM AND METHOD FOR MANUFACTURING SAME, AND BONDING STRUCTURE AND ULTRASONIC BIOMETRIC IDENTIFICATION APPARATUS

(71) Applicant: JIANGXI OUMAISI MICROELECTRONICS CO., LTD., Nanchang (CN)

(72) Inventor: Xuanxuan LIU, Nanchang (CN)

(73) Assignee: JIANGXI OUMAISI MICROELECTRONICS CO., LTD., Nanchang (CN)

(21) Appl. No.: 17/636,742

(22) PCT Filed: Dec. 9, 2019
(86) PCT No.: PCT/CN2019/123935

§ 371 Date: Feb. 18, 2022

(30) Foreign Application Priority Data
Sep. 10, 2019 (CN) 201910851810.0

(51) Int. Cl. C08J 5/18; G06V 40/13; C08L 63/00

(52) U.S. Cl. CPC C08J 5/18; G06V 40/1306; C08L 63/00; C08J 2363/00; C08L 2203/20

(57) ABSTRACT

The present invention relates to an anisotropic conductive film and a method for manufacturing same, and a bonding structure and an ultrasonic biometric identification apparatus. The anisotropic conductive film comprises first conductive particles and second conductive particles, wherein the particle size of the first conductive particles is less than the particle size of the second conductive particles, and the ratio of the number of the first conductive particles to the number of the second conductive particles is (3-8):1. The anisotropic conductive film is applicable to pins made of different materials, and is particularly applicable to a bonding structure where a pin made of a relatively hard material and a pin made of a relatively loose material exist at the same time, thereby ensuring that the anisotropic conductive film has a relatively low conduction impedance and excellent conduction stability on both of the two materials.

### CROSS-REFERENCE TO RELATED APPLICATION

This application is a national stage, filed under 35 U.S.C. § 371, of International Application No. PCT/CN2019/123935, filed on Dec. 9, 2019, and entitled “ANISOTROPIC CONDUCTIVE FILM AND METHOD FOR MANUFACTURING SAME, AND BONDING STRUCTURE AND ULTRASONIC BIOMETRIC IDENTIFICATION APPARATUS”, which claims priority from Chinese Patent Application No. 201910851810.0, filed on Sep. 10, 2019, the entire content of each of which is incorporated herein by reference.

### TECHNICAL FIELD

The present disclosure relates to the field of material technology, in particular to an anisotropic conductive film and a method for preparing the same, a bonding structure and an ultrasonic biometric device.

### BACKGROUND

A touch panel usually includes a sensing substrate for sensing user's touch information, a flexible printed circuit board (FPC) for transmitting the touch information to a control device, and an anisotropic conductive film (ACF) that electrically connects pins on the sensing substrate to pins of the flexible circuit board. Under the bonding process conditions, conductive particles of the ACF are deformed and broken, to achieve electrical connection. Depending on the different materials used to make the pins, it is usually necessary to select an appropriate ACF to achieve good conduction stability. However, when there are pins made of various materials in the bonding structure, the conventional ACF is difficult to adapt, which easily leads to poor circuit contact or short circuit risk.

### SUMMARY

Accordingly, it is necessary to provide an anisotropic conductive film applicable for pins made of various materials and a method for preparing the same.

In addition, a bonding structure and an ultrasonic biometric device prepared by using the above anisotropic conductive film are further provided.

An anisotropic conductive film includes a base resin, first conductive particles, and second conductive particles. The first conductive particles and the second conductive particles are dispersed in the base resin. A particle size of the first conductive particles is smaller than a particle size of the second conductive particles. A ratio of the number of the first conductive particles to the number of the second conductive particles is in a range of (3-8):1.

A method for preparing an anisotropic conductive film includes:

uniformly mixing first conductive particles, second conductive particles, and a base resin, and then curing, to obtain the anisotropic conductive film. A particle size of the first conductive particles is smaller than a particle size of the second conductive particles. A ratio of the number of the first conductive particles to the number of the second conductive particles is in a range of (3-8):1.

A bonding structure includes a substrate and a flexible circuit board. A first pin and a second pin are connected to the substrate. The first pin and the second pin are bonded to the flexible printed circuit board through an anisotropic conductive film. The anisotropic conductive film is the anisotropic conductive film as described above, or, the anisotropic conductive film is the anisotropic conductive film prepared by the method as described above.

An ultrasonic biometric device includes the bonding structure as described above. The ultrasonic biometric device prepared by the above-mentioned bonding structure has good stability, accurate identification function, and long service life.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate the embodiments and/or examples of those solutions disclosed herein, reference may be made to the accompanying drawings. The additional details or examples used to describe the drawings should not be considered as limiting the scope of any of the disclosed solutions, the currently described embodiments and/or examples, and the best mode of these solutions currently understood.

FIG. 1 is a schematic view of a bonding structure according to an embodiment.

### DETAILED DESCRIPTION OF THE EMBODIMENTS

In order to facilitate the understanding of the present disclosure, the present disclosure will be described more fully below with reference to the relevant drawings. The preferred embodiments of the present disclosure are shown in the drawings. However, the present disclosure can be implemented in many different forms and is not limited to the embodiments described herein. On the contrary, the purpose of providing these embodiments is to make the understanding of the disclosure of the present disclosure more thorough and comprehensive.

Unless otherwise defined, all technical and scientific terms used herein have the same meaning as commonly understood by those skilled in the technical field of the present disclosure. Terms used in the description of the present disclosure herein are only for the purpose of describing specific embodiments, and are not intended to limit the present disclosure.

An anisotropic conductive film according to an embodiment includes a base resin, first conductive particles, and second conductive particles. The first conductive particles and the second conductive particles are dispersed in the base resin. A particle size of the first conductive particles is smaller than that of the second conductive particles. A ratio of the number of the first conductive particles to the number of the second conductive particles is in a range of (3-8):1.

By selecting two kinds of conductive particles with different particle sizes and combining the two according to a specific ratio, the resulting anisotropic conductive film can be applied to pins made of different materials, and has lower conduction resistance and excellent conduction stability on the pins made of different materials.

Further, the particle size of the first conductive particles is in a range of 2 μm to 4 μm, and the particle size of the second conductive particles is in a range of 7 μm to 9 μm. Furthermore, the particle size of the first conductive particles is 3 μm, and the particle size of the second conductive particles is 8 μm. When the two kinds of conductive particles with the above-mentioned particle sizes are used, the resulting anisotropic conductive film is particularly applicable for a bonding structure where there are both pins made of harder material and pins made of looser material, ensuring that the anisotropic conductive films on the harder material and the looser material have lower conduction resistance and excellent conduction stability.

In a specific embodiment, the ratio of the number of the first conductive particles to the number of the second conductive particles is 5:1. The anisotropic conductive film obtained with this ratio of the first conductive particles to the second conductive particles is particularly applicable for the bonding structure where there are both pins made of harder material and pins made of looser material. The conductive particles with the two different particle sizes can achieve good deformation and breaking effects in a bonding area where the pins made of harder material are located and a bonding area where the pins made of looser material are located, ensuring that the anisotropic conductive film has low conduction resistance and excellent conduction stability on both kinds of materials.

Further, in the base resin, a density of the first conductive particles is in a range of 3000 pcs/mm² to 5000 pcs/mm², and a density of the second conductive particles is in a range of 600 pcs/mm² to 1000 pcs/mm². When the density of the first conductive particles and the density of the second conductive particles are within the above ranges, the anisotropic conductive film has better overall uniformity.

The first conductive particles and the second conductive particles can be made of conventional materials in the art. In one embodiment, the first conductive particles and the second conductive particles are made of at least one material independently and respectively selected from carbon, metal, and metal/resin composite materials. The above-mentioned conductive particles have good conductivity. The metal may be at least one of nickel, copper, and palladium. Nickel, copper, and palladium have excellent electrical conductivity and stable conduction, and are particularly applicable for preparing the anisotropic conductive film. The resin in the metal/resin composite material can be at least one of epoxy resin and acrylic resin. The conductive particles prepared by compounding the above-mentioned resin and the metal have lower conduction resistance and good conduction stability. Shapes of the first conductive particles and the second conductive particles are generally spherical. When the first conductive particles or the second conductive particles are made of a metal material, the first conductive particles or the second conductive particles can be made of one type of metal or made of multiple types of metals. For example, the first conductive particles or the second conductive particles are directly nickel balls, or particles obtained by wrapping a copper layer on the nickel balls. When the first conductive particles or the second conductive particles are made of a metal/resin composite material, the metal/resin composite material may further be at least one of a nickel/resin composite material, a nickel-copper/resin composite material, and a nickel-palladium/resin composite material. When the first conductive particles or the second conductive particles are made of a metal/resin composite material, the first conductive particles or the second conductive particles can have a structure in which a resin is a core, a metal layer is wrapped on a surface of the resin, and a resin layer is optionally wrapped around the metal layer, which forms a resin core/metal shell structure or a resin core/metal shell/resin shell structure, where “/” refers to a layered structure.

Furthermore, the first conductive particles are made of nickel, and the second conductive particles are made of a nickel/resin composite material. The anisotropic conductive film prepared by using the first conductive particles and the second conductive particles made of the above-mentioned materials is particularly applicable for the bonding structure where there are the pins made of harder material and the pins made of looser material, which can ensure a smaller resistance and excellent conduction stability.

The type of base resin may be conventional in the art. In one embodiment, the base resin may be at least one selected from acrylic resin and epoxy resin. The above-mentioned base resins have good bonding stability and are particularly applicable for the preparation of anisotropic conductive films.

In one of the embodiments, in order to further improve the overall performance of the anisotropic conductive film, the anisotropic conductive film may further include an additive. The additive may be of various conventional types capable of achieving the above-mentioned objects, and which is not particularly limited in the present disclosure. The amount of the additive can be adjusted as needed.

A method for preparing an anisotropic conductive film according to an embodiment includes:

uniformly mixing first conductive particles, second conductive particles, and a base resin, followed by curing, to obtain an anisotropic conductive film. The particle size of the first conductive particles is smaller than the particle size of the second conductive particles, and a ratio of the number of the first conductive particles to the number of the second conductive particles is in a range of (3-8):1.

By selecting two kinds of conductive particles with different particle sizes, and uniformly mixing them with the base resin according to a specific ratio, followed by curing, the prepared anisotropic conductive film can be applied to pins made of different materials.

Further, the particle size of the first conductive particles is in a range of 2 μm to 4 μm, and the particle size of the second conductive particles is in a range of 7 μm to 9 μm. Furthermore, the particle size of the first conductive particles is 3 μm, and the particle size of the second conductive particles is 8 μm. When the two kinds of conductive particles with the above-mentioned particle sizes are used, the resulting anisotropic conductive film is particularly applicable for the bonding structure where there are both pins made of harder material and pins made of looser material, ensuring that the anisotropic conductive film on the harder material and the looser material have lower conduction resistance and excellent conduction stability.

In a specific embodiment, the ratio of the number of the first conductive particles to the number of the second conductive particles is 5:1. The anisotropic conductive film obtained with this ratio of the first conductive particles to the second conductive particles is particularly applicable for the bonding structure where there are both pins made of harder material and pins made of looser material. The conductive particles with the two different particle sizes can achieve good deformation and breaking effects in a bonding area where the pins made of harder material are located and a bonding area where the pins made of looser material are located, ensuring that the anisotropic conductive film has low conduction resistance and excellent conduction stability on both kinds of materials.

The first conductive particles and the second conductive particles are made of materials as described above, and which will not be repeated herein. Further, in the prepared anisotropic conductive film, a density of the first conductive particles is in a range of 3000 pcs/mm² to 5000 pcs/mm², and a density of the second conductive particles is in a range of 600 pcs/mm² to 1000 pcs/mm². When the density of the first conductive particles and the density of the second conductive particles are within the above range, the prepared anisotropic conductive film has better overall uniformity. For the kinds of the base resin, reference may be made to the above description, which will not be repeated herein.

In one of the embodiments, before curing, an additive is further added. That is, the first conductive particles, the second conductive particles, the base resin, and the additive are mixed uniformly, and then cured to obtain the anisotropic conductive film. Adding the additive can further improve the overall performance of the anisotropic conductive film. The additive may be of various conventional types capable of achieving the above-mentioned objects, and which is not particularly limited in the present disclosure. The amount of the additive can be adjusted as needed.

Further, the curing conditions may include: a temperature of 150° C. to 180° C., a pressure of 3 MPa to 10 MPa, and a time of 2 seconds to 10 seconds.

Through the above method, the first conductive particles and the second conductive particles in a specific ratio are uniformly mixed with the base resin, and then cured, to obtain the anisotropic conductive film. After curing, the resulting product can be measured to ensure that the ratio of the number the first conductive particles to the number of the second conductive particles, the density of the first conductive particles, and the density of the second conductive particles are within the above range, so as to be applicable for the pins made of different materials.

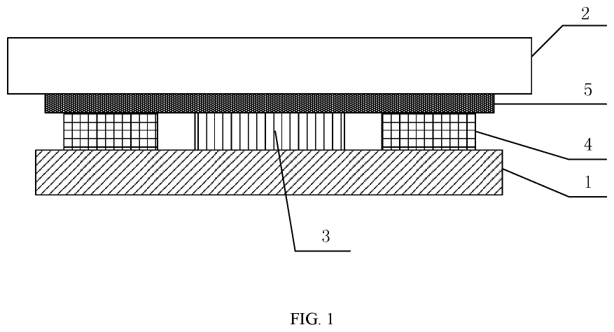

According to an embodiment, referring to FIG. 1, a bonding structure includes a substrate 1 and a flexible printed circuit board 2. A first pin 3 and a second pin 4 are connected to the substrate 1. The first pin 3 and the second pin 4 are bonded to the flexible printed circuit board through the anisotropic conductive film 5. The anisotropic conductive film 5 is the above-mentioned anisotropic conductive film.

The first pin 3 and the second pin 4 are made of different materials, which may be a harder material and a looser material, respectively. The above-mentioned anisotropic conductive film can have lower conduction resistance and excellent conduction stability on both kinds of materials, and achieve stable electrical connection between the pins made of the two materials and the flexible circuit board, resulting in no poor circuit contact or short circuit phenomenon. The bonding structure product has excellent overall performance.

In a specific embodiment, the first pin 3 is an indium tin oxide (ITO)-metal pin, and the second pin 4 is a silver paste pin. In the bonding structure, due to the above-mentioned anisotropic conductive film, the conductive particles with two particle sizes in the bonding area where the ITO-metal pin is located and the bonding area where the silver paste pin is located, can achieve good deformation and breaking effects, such that the electrical connection of the bonding structure is stable. The bonding structure prepared by using the pins made of the above two materials is particularly applicable for ultrasonic biometric devices. Further, the metal used to make the ITO-metal pin may be a molybdenum-aluminum-molybdenum composite metal.

The number of the first pins 3 and the number of the second pins 4 are not particularly limited, and can be adjusted as needed. The substrate 1 and the flexible printed circuit board 2 are not particularly limited in respective structures and types, and can be any commonly used substrates and flexible circuit boards in the art.

An ultrasonic biometric device according to an embodiment includes the above-mentioned bonding structure. The substrate 1 may be a thin film transistor (TFT) glass plate.

The ultrasonic biometric device prepared by the above-mentioned bonding structure has good stability, accurate identification function, and long service life.

The present disclosure will be further illustrated in following examples, but which are not used to limit the present disclosure.

Raw materials used in the examples are all commercially available.

### Example 1

In an anisotropic conductive film according to this example, the first conductive particles were metallic Ni balls (with a particle size of 3 μm), the second conductive particles were resin balls (with a particle size of 8 μm) plated with Ni on an outer layer, and the base resin was epoxy resin.

The first conductive particles and the second conductive particles in a ratio of 5:1 were mixed with the epoxy resin, stirred uniformly, and cured at 160° C. and at 5 MPa for 5 seconds, to obtain the anisotropic conductive film. A measurement was performed by a microscope, it was obtained that a density of the first conductive particles was 4020 pcs/mm² and a density of the second conductive particles was 810 pcs/mm², and the anisotropic conductive film had a better overall uniformity.

### Example 2

The process of preparing an anisotropic conductive film according to this example was substantially the same as that of Example 1, except that a particle size of the first conductive particles was 5 μm, and a particle size of the second conductive particles was 6 μm. A measurement was performed by a microscope, it was obtained that a density of the first conductive particles was 3980 pcs/mm², and a density of the second conductive particles was 825 pcs/mm², and the anisotropic conductive film had better overall uniformity.

### Example 3

The process of preparing an anisotropic conductive film according to this example was substantially the same as that of Example 1, except that a ratio of the number of the first conductive particles to the number of the second conductive particles was 4:1, a density of the first conductive particles was 2150 pcs/mm², and a density of the second conductive particles was 560 pcs/mm², and the anisotropic conductive film had better overall uniformity.

### Comparative Example 1

In an anisotropic conductive film according to this comparative example, the conductive particles were resin balls (with a particle size of 8 μm) plated with Ni on an outer layer, and the base resin was epoxy resin.

The conductive particles are mixed with the epoxy resin, stirred uniformly, and cured at 160° C. and at 5 MPa for 5 seconds, to obtain the anisotropic conductive film. A measurement was performed by a microscope, it was obtained that the density of conductive particles is 4025 pcs/mm².

### Comparative Example 2

The process of preparing the anisotropic conductive film according to this comparative example is substantially the same as that of Example 1, except that the ratio of the number of the first conductive particles to the number of the second conductive particles was 2:1. A measurement was performed by a microscope, it was obtained that the density of the first conductive particles was 1635 pcs/mm², and the density of the second conductive particles was 820 pcs/mm².

### Comparative Example 3

The process of preparing the anisotropic conductive film according to this comparative example is substantially the same as that of Example 1, except that the ratio of the number of the first conductive particles to the number of the second conductive particles was 9:1. A measurement was performed by a microscope, it was obtained that the density of the first conductive particles was 4490 pcs/mm², and the density of the second conductive particles was 490 pcs/mm².

### Example 4

The bonding structure according to this example is as shown in FIG. 1, where the substrate 1 was a TFT substrate, the first pin 3 was an ITO-molybdenum/aluminum/molybdenum pin, and the second pin 4 was a silver paste pin, the anisotropic conductive film was the anisotropic conductive film prepared in Example 1. The TFT substrate and the flexible printed circuit board (FPC) were prepared, and then, the anisotropic conductive film was placed on the TFT substrate, and bonded to the ITO-molybdenum/aluminum/molybdenum pins in a first portion, and then bonded to the silver paste pins in a second portion. The prepared bonding structure had no bubbles and good glue over fill on the front and back sides.

### Examples 5-6

The process of preparing a bonding structure according to this example was substantially the same as that of Example 4, except that the anisotropic conductive film prepared in Example 1 was replaced with the anisotropic conductive films prepared in Examples 2 to 3, respectively. The anisotropic conductive film in the prepared bonding structure had no bubbles and good glue over fill on the front and back sides.

### Comparative Examples 4-6

Bonding structures were prepared according to the method of Example 4, except that the anisotropic conductive film prepared in Example 1 was replaced with the anisotropic conductive films prepared in Comparative Examples 1 to 3, respectively.

### Test Example 1

The bonding structures prepared in Examples 4-6 and Comparative Examples 4-6 were sliced and the heights of the particles were observed under a scanning electron microscope (SEM). The test results of the breaking conditions of the conductive particles, the indentation, the bonding gap and the deformation rate of the conductive particles were listed in the Table 1.

TABLE 1

| | | | | | Deformation | Deformation |
|---|---|---|---|---|---|---|
| | Breaking condition | Breaking condition | | | rate of the | rate of the |
| | of the conductive | of the conductive | | | first | second |
| | particles in the | particles in the | | Bonding | conductive | conductive |
| | first pin area | second pin area | Indentation | gap/μm | particles/% | particles/% |
| Example 4 | OK | OK | Obvious | 2.5 | 75 | 77 |
| Example 5 | OK | OK | Obvious | 2.8 | 71 | 73 |
| Example 6 | OK | OK | Obvious | 2.9 | 65 | 68 |
| Comparative | NG | NG | Not obvious | 3.3 | 22 | 18 |
| Example 4 | | | | | | |
| Comparative | NG | NG | Not obvious | 3.5 | 34 | 35 |
| Example 5 | | | | | | |
| Comparative | NG | NG | Not obvious | 3.8 | 47 | 43 |
| Example 6 | | | | | | |

It can be seen from Table 1 that the conductive particles in the first pin area and the second pin area of the bonding structure prepared by the anisotropic conductive film of the present disclosure have good breaking conditions, very obvious indentation, and the bonding gap not exceeding 3 μm, which can ensure that both the first conductive particles and the second conductive particles can be in contact with the flexible printed circuit board and the pins, and the deformation rates of the first conductive particles and the second conductive particles are relatively high.

### Test Example 2

Conducting impedance tests were performed on the bonding structures prepared in Examples 4-6 and Comparative Examples 4-6 in a high-temperature and high-humidity environment (temperature of 85° C., humidity of 85% RH), and a universal tensile machine was used to perform drawing force tests. The results were listed in Table 2.

TABLE 2

| | | Conduction stability | | drawing |
|---|---|---|---|---|
| | Conducting | 250 h | 500 h | force, |
| | impedance, | Conducting | Conducting | N/cm |
| | Ω | impedance, Ω | impedance, Ω | Ω |
| Example 4 | 0.0377 | 0.0401 | 0.0422 | 13.5 |
| Example 5 | 0.1459 | 0.1511 | 0.1724 | 12.1 |
| Example 6 | 0.1807 | 0.1968 | 0.2126 | 10.9 |
| Comparative | 3.60 | 4.47 | 5.56 | 7.5 |
| Example 4 | | | | |
| Comparative | 5.43 | 6.87 | 8.49 | 8.1 |
| Example 5 | | | | |
| Comparative | | | | |
| Example 6 | 2.78 | 4.16 | 5.19 | 8.4 |

It can be seen from Table 2 that the bonding structure prepared by using the anisotropic conductive film of the present disclosure has lower conducting impedance, which changes little after long-term use, better conduction stability, higher drawing force, good bonding stability, excellent overall product performance.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements falls in the protection scope of the present disclosure. Therefore, the protection scope of the present disclosure shall be subject to the appended claims.

What is claimed is:

1. An anisotropic conductive film, comprising a base resin, first conductive particles, and second conductive particles, wherein the first conductive particles and the second conductive particles are dispersed in the base resin, a particle size of the first conductive particles is smaller than a particle size of the second conductive particles, and a ratio of the number of the first conductive particles to the number of the second conductive particles is in a range of (3-8):1.

2. anisotropic conductive film according to claim 1, wherein the particle size of the first conductive particles is in a range of 2 μm to 4 μm, and the particle size of the second conductive particles is in a range of 7 μm to 9 μm.

3. The anisotropic conductive film according to claim 2, wherein the particle size of the first conductive particles is 3 μm, and the particle size of the second conductive particles is 8 μm.

4. The anisotropic conductive film according to claim 1, wherein the ratio of the number of the first conductive particles to the number of the second conductive particles is 5:1.

5. The anisotropic conductive film according to claim 1, wherein in the base resin, a density of the first conductive particles is in a range of 3000 pcs/mm² to 5000 pcs/mm², and a density of the second conductive particles is in a range of 600 pcs/mm² to 1000 pcs/mm².

6. The anisotropic conductive film according to claim 1, wherein the first conductive particles and the second conductive particles are made of at least one material independently and respectively selected from carbon, metal, and metal/resin composite materials.

7. The anisotropic conductive film according to claim 6, wherein the metal is at least one of nickel, copper, and palladium.

8. The anisotropic conductive film according to claim 6, wherein the resin in the metal/resin composite material is at least one of epoxy resin and acrylic resin.

9. The anisotropic conductive film according to claim 6, wherein the first conductive particles are made of nickel, and the second conductive particles are made of nickel/resin composite material.

10. The anisotropic conductive film according to claim 1, wherein the base resin is at least one selected from acrylic resin and epoxy resin.

11. A method for preparing an anisotropic conductive film, comprising:
uniformly mixing first conductive particles, second conductive particles, and a base resin, and then curing, to obtain the anisotropic conductive film,
wherein a particle size of the first conductive particles is smaller than a particle size of the second conductive particles, and a ratio of the number of the first conductive particles to the number of the second conductive particles is in a range of (3-8):1.

12. The method according to claim 11, wherein the particle size of the first conductive particles is in a range of 2 μm to 4 μm, and the particle size of the second conductive particles is in a range of 7 μm to 9 μm.

13. The method according to claim 12, wherein the particle size of the first conductive particles is 3 μm, and the particle size of the second conductive particles is 8 μm.

14. The method according to claim 11, wherein the ratio of the number of the first conductive particles to the number of the second conductive particles is 5:1.

15. The method according to claim 11, wherein in the anisotropic conductive film, a density of the first conductive particles is in a range of 3000 pcs/mm² to 5000 pcs/mm², and a density of the second conductive particles is in a range of 600 pcs/mm² to 1000 pcs/mm².

16. A bonding structure, comprising a substrate and a flexible circuit board, wherein a first pin and a second pin are connected to the substrate; the first pin and the second pin are bonded to the flexible printed circuit board through an anisotropic conductive film,
wherein the anisotropic conductive film is the anisotropic conductive film according to claim 1, or, the anisotropic conductive film is the anisotropic conductive film prepared by the method according to claim 11.

17. The bonding structure according to claim 16, wherein the first pin and the second pin are made of different materials.

18. The bonding structure according to claim 17, wherein the first pin is an indium tin oxide (ITO)-metal pin, and the second pin is a silver paste pin.

19. An ultrasonic biometric device, comprising the bonding structure according to claim 16.
